(19) United States
(12) Patent Application Publication
(10) Pub. No.: US 2003/0143018 A1
(43) Pub. Date: Jul. 31, 2003

(54) Greeting card album pages and albums using the same

(76) Inventor: Nathalie T. Warriner, Orchard Lake, MI (US)

Correspondence Address: WHITE & CASE LLP, PATENT DEPARTMENT, 1155 AVENUE OF THE AMERICAS, NEW YORK, NY, 10036, US

(21) Appl. No.: 10/056,896

(22) Filed: Jan. 25, 2002

(51) Int. Cl. B42F 13/00

(52) U.S. Cl. 402/79

(57) ABSTRACT

The invention is a greeting card album page and albums using the same. The page comprises a backing sheet having one or more pockets formed thereon by one or more transparent overlays traversing across the page. The pockets may be oriented to form a vertical pocket for receiving vertically opening cards, or a horizontal pocket for receiving horizontally opening cards. In an alternative embodiment, the page comprises a backing sheet having a plurality of strips formed by cutting pairs of slits into the sheet. The strips are adapted for receiving the fold of the card, which seats on the strip, and may be horizontally or vertically oriented. In an additional embodiment, the page comprises a plurality of adhesive patches covered by protective overlays. The invention also provides greeting card albums containing the album pages of the invention.

### FIELD OF THE INVENTION

The present invention relates generally to storage albums and pages used therein. In particular, the invention concerns a page for holding and displaying greeting cards.

### BACKGROUND OF THE INVENTION

Most people who receive greeting cards display them for a period of time (on a fireplace mantel, for example) and thereafter store them away for keepsake purposes. Unfortunately, over the course of time, most people end up simply throwing the cards into a drawer, shoe-box or the like. Storing greeting cards in this manner frequently results in the loss or destruction of the cards. At a later date, it can often be very difficult to find a particular card, and one must often search through many cards to locate a desired card.

Several greeting card albums have been developed to address the host of problems associated with storing and displaying old greeting cards. The relevant prior art includes the following patents: U.S. Pat. No. 6,312,183, issued Nov. 6, 2001, to Arnold; U.S. Pat. No. 5,772,349, issued Jun. 30, 1998, to Tubergen; U.S. Pat. No. 5,713,684, issued Feb. 3, 1998 to Turecamo (now Warriner); U.S. Pat. No. 5,573,276 issued Nov. 12, 1996, Nomura et al.; and U.S. Pat. No. 4,965,948, issued Oct. 30, 1990, to Ruebens.

### SUMMARY OF THE INVENTION

The present invention provides a greeting card album page for holding and displaying greeting cards. In an embodiment for holding and displaying vertically opening cards, the invention includes a backing sheet having left, right, top and bottom edges and a fastening section along the left edge for engagement with a fastener of the album. One or more vertical pockets are disposed over the backing sheet. Each pocket is formed by a transparent overlay having an upper edge, a lower edge, and a side edge connected to the backing sheet. Each pocket receives a portion or all of a greeting card. In particular, the pocket will receive the back-fold of the card so that the front-fold may be opened and closed as desired.

In an embodiment for holding and displaying horizontally opening cards, the page includes one or more horizontal pockets over the backing sheet, and each pocket is formed by a transparent overlay having an inner edge, an outer edge, and a bottom edge connected to the backing sheet. The upwardly facing pocket will receive a portion or all of the greeting card.

The pages for holding and displaying vertically opening cards and horizontally opening cards may be configured to hold the cards in a cascading manner. The cascading configuration allows for more cards to be stored on a single page by partly overlapping the cards. To facilitate the display of cards, the transparent overlay can optionally extend across the entire length or width of the backing sheet. However, the pocket can be shorter or narrower than the entire length or width, respectively, of the sheet. In such situations, the portion of the sheet not covered by the overlay can be used to record notes or comments about a particular greeting card. Additionally, the pages according to the claimed invention may optionally have a pre-printed memo area adjacent to a pocket to facilitate recordation of notes, such as dates or occasions.

In another embodiment of the invention, the page comprises a backing sheet having a fastening section along the left edge for engagement with a fastener of the album, and a plurality of strips formed by cutting pairs of slits into the backing sheet, each strip for receiving the fold line of a greeting card. In this embodiment, the back-fold of a greeting card is leafed through the slits until the fold line of the card seats on the strip. The page includes a number of strips, which may accommodate a corresponding number of cards. The strips may be positioned adjacent to one another so that the cards are stored in a cascading manner.

In another embodiment of the invention, the page comprises a backing sheet having a fastening section along the left edge for engagement with a fastener of the album, and a plurality of adhesive patches disposed on the backing sheet. Each patch may be covered by a detachable protective overlay. In this embodiment, a greeting card is removably mounted onto the page by partly or wholly removing one or more protective overlays, thereby exposing one or more adhesive patches, and placing the card directly on top of the exposed adhesive. One or more cards may thus be mounted on a single page, and a card may be repositioned by merely lifting the card from the page and placing it in another position on the same or different page. The protective overlay may be imprinted with a graphical design or be cut into a recognizable shape, such as a heart or star.

The invention also comprises a greeting card album comprising a binder having front and back covers and a fastener for retaining one or more pages between the covers. The binder includes one or more of the album pages of the invention. The fastener may be a conventional three-ring fastener, a twin-loop spiral, a spiral coil binding, plastic comb binding, or any other type of fastener which can retain the pages of the album.

### BRIEF DESCRIPTION OF THE FIGURES

FIG. 1 shows a plan view of a greeting card album page according to a first embodiment of the invention.

FIG. 2 shows a plan view of a greeting card album page according to a second embodiment of the invention.

FIG. 3 shows a plan view of a greeting card album page according to a third embodiment of the invention.

FIG. 4 shows a plan view of a greeting card album page according to a fourth embodiment of the invention.

FIG. 5 shows a perspective view of a greeting card album page according to a fifth embodiment of the invention.

FIG. 6 shows a perspective view of a greeting card album page according to a sixth embodiment of the invention.

FIG. 7 shows a perspective view of a greeting card album according to the invention.

### DETAILED DESCRIPTION OF THE INVENTION

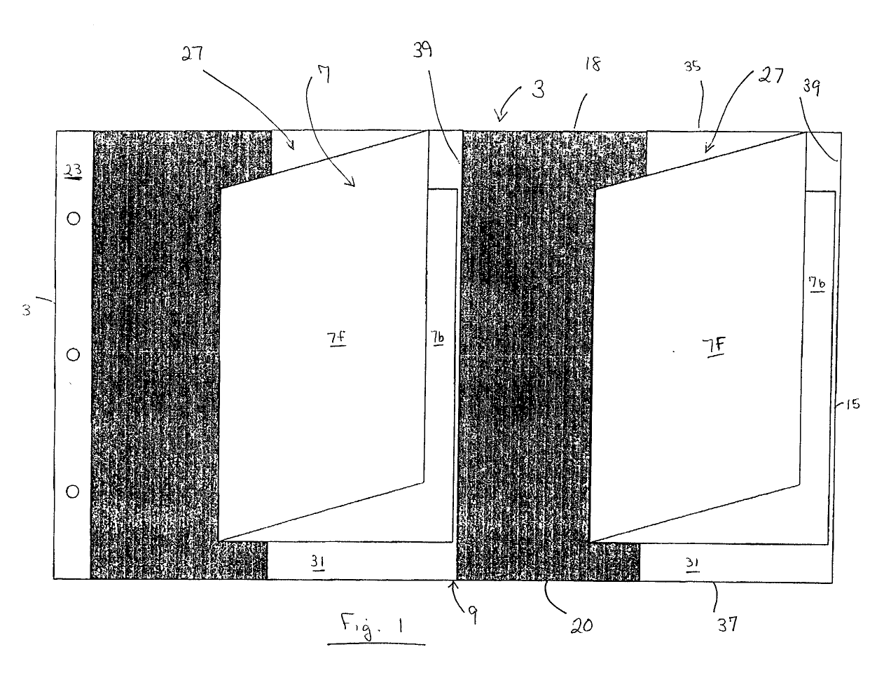

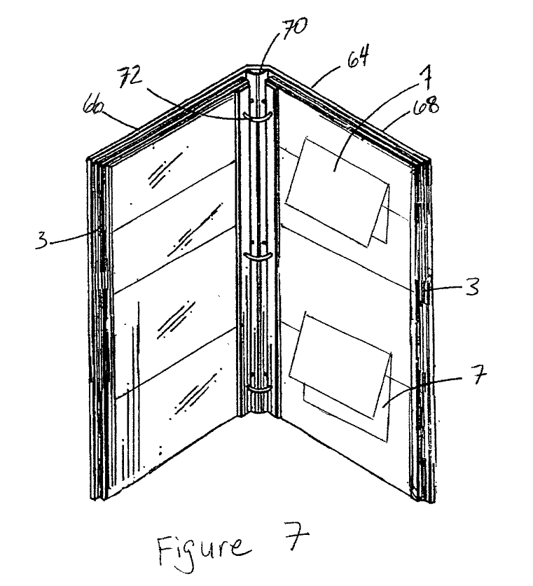

Several embodiments of the claimed invention will now be described by reference to the Figures, wherein like reference numeral designate like components. FIG. 1 shows a greeting card album page 3 according to a first embodiment of the invention for storing and displaying vertically opening greeting cards 7. The album page 3 is composed of a backing sheet 9 having left edge 13, right edge 15, top edge 18 and bottom edge 20. A fastening section 23 is disposed along the left edge 13 for engagement with a fastener of an album (not shown in the figure). The fastening section 23 will typically comprise a three-hole punched portion of the page, which engages the rings of a three-ring binder (see FIG. 7). One or more vertical pockets 27 are placed over the backing sheet. Each pocket is formed by a transparent overlay 31 having an upper edge 35 connected to the top edge 18 of the backing sheet, a lower edge 37 connected to the bottom edge 20 of the backing sheet, and a side edge 39 connected to the backing sheet. The overlay is typically connected to the backing sheet by heat sealing.

The side of each pocket opposite side edge 39 forms an opening for receiving a portion or all of a greeting card. In the present embodiment, the back-fold 7b of card 7 is inserted into the pocket 27 leaving the front-fold 7f free. The overlay 31 forming the pocket 27 is made of transparent material so that the print material on the back-fold 7b may be read when the card is opened while it is in the album page. The front-fold 7f remains free to open and close as desired.

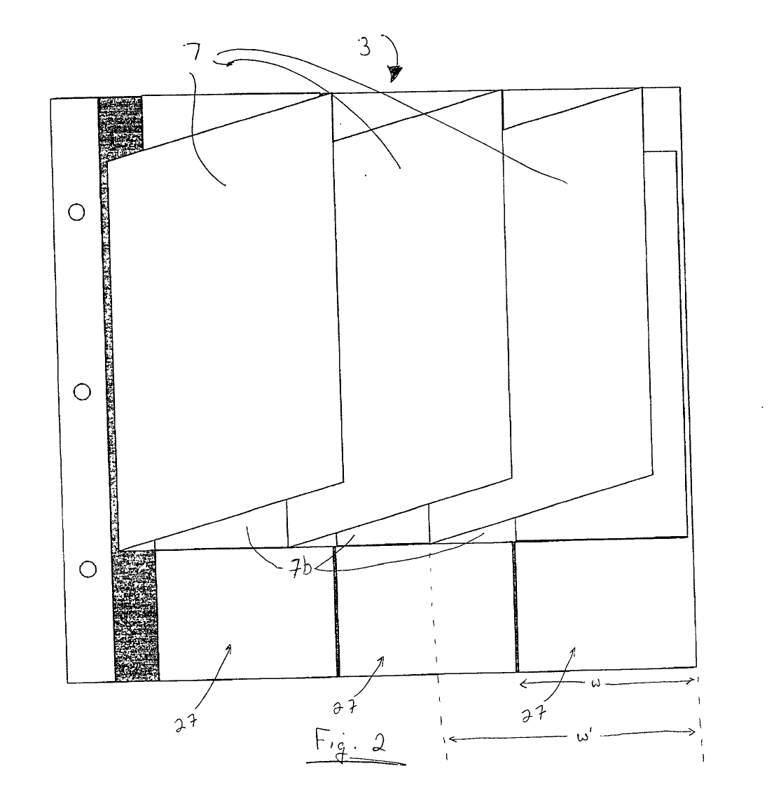

FIG. 2 shows an album page that is similar to FIG. 1 and that also provides for saving space by mounting the cards in a cascading fashion. In particular, FIG. 2 shows a page 3 having a plurality of pockets 27 covering the entire page. Each pocket 27 has a width w that is less than the width of the card w′ to be placed therein. When the cards 7 are loaded into the page 3, the cards 7 (in particular the back-folds 7b) will overlap one another. The overlapping cascade of cards allows for storage of more cards on a particular album page. When a particular card 7 is opened, a portion of the print material on the interior of the back-fold may be obscured by the next card in the cascade, but the card may be slid out of its individual pocket so that the print material may be viewed.

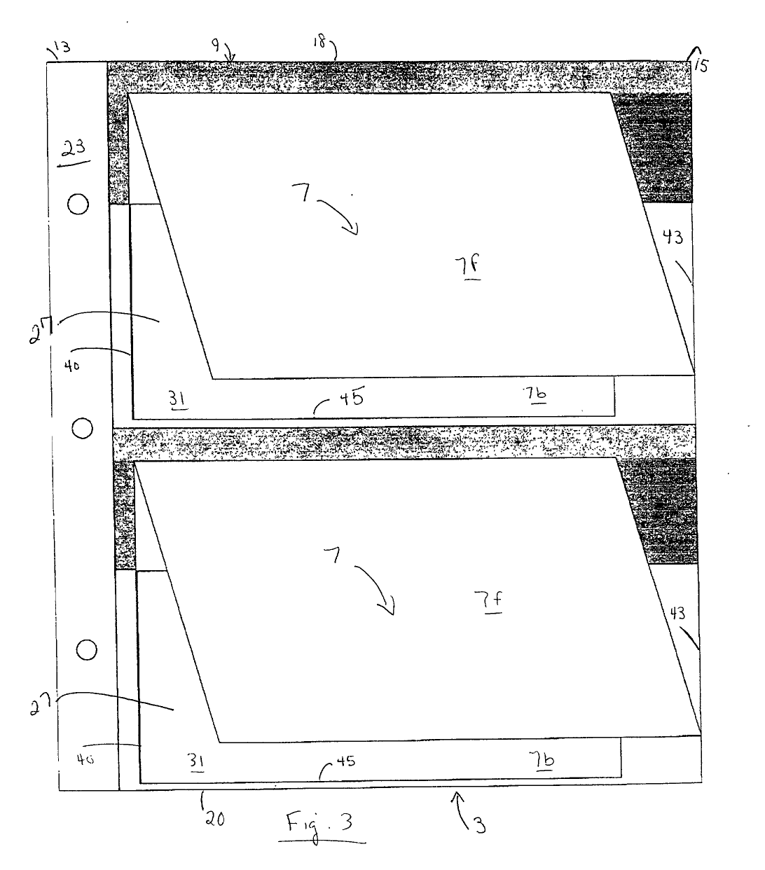

FIG. 3 shows a greeting card album page 3 according to a third embodiment of the invention for storing and displaying horizontally oriented greeting cards 7. As in the previous embodiments, page 3 is composed of a backing sheet 9 having left edge 13, right edge 15, top edge 18 and bottom edge 20. A fastening section 23 is disposed along the left edge 13 for engagement with a fastener of an album (not shown in the figure). One or more horizontal pockets 27 is placed over the backing sheet. Each pocket is formed by a transparent overlay 31 having an inner edge 40 connected to the left edge 13 of the backing sheet, an outer edge 43 connected to the right edge 15 of the backing sheet, and a bottom edge 45 connected to the backing sheet 9.

The side of each pocket opposite bottom edge 45 forms an opening for receiving a portion or all of a greeting card. The back-fold 7b of card 7 is inserted into the pocket 27 leaving the front-fold 7f free. The overlay 31 forming the pocket 27 is made of transparent material so that the print material on the back-fold 7b may be read when the card is opened while it is in the album page. The front-fold 7f remains free to open and close as desired.

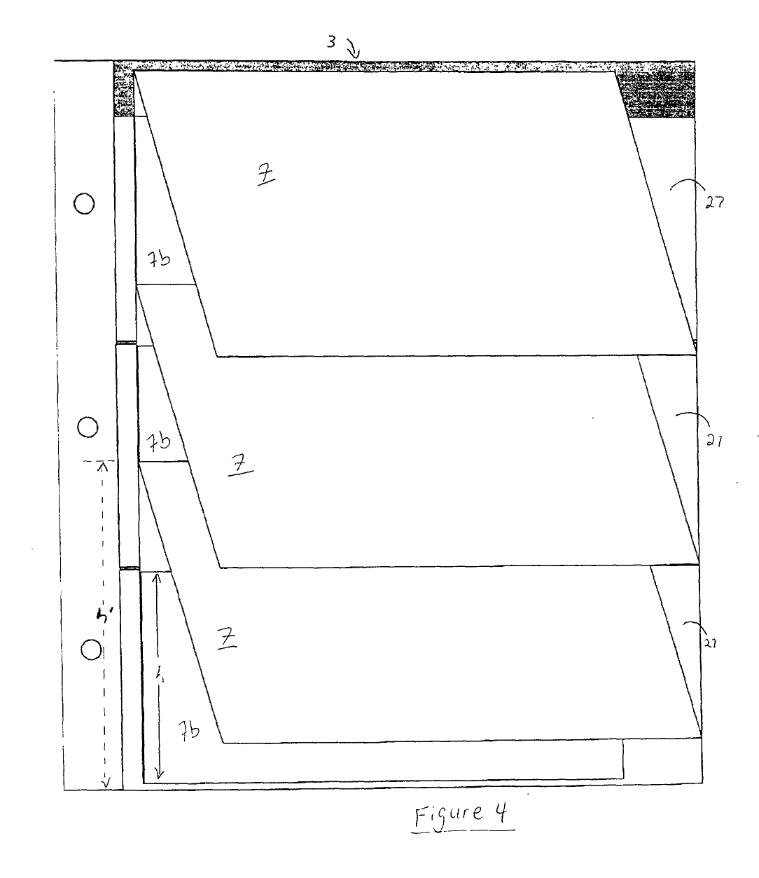

FIG. 4 shows an embodiment of a page for storing and displaying horizontal greeting cards in a cascading manner. FIG. 4 shows a page 3 having a plurality of pockets 27 covering the entire page. Each pocket 27 has a height “h” that is less than the height of the card h′ to be placed therein. When the cards 7 are loaded into the page 3, the cards 7 (in particular the back-folds 7b) will overlap one another. The overlapping cascade of cards allows for storage of more cards on a particular album page. When a particular card 7 is opened, the print material on the interior of the back-fold may be obscured by the next card in the cascade, but the card may be slid out of its individual pocket so that the print material may be viewed.

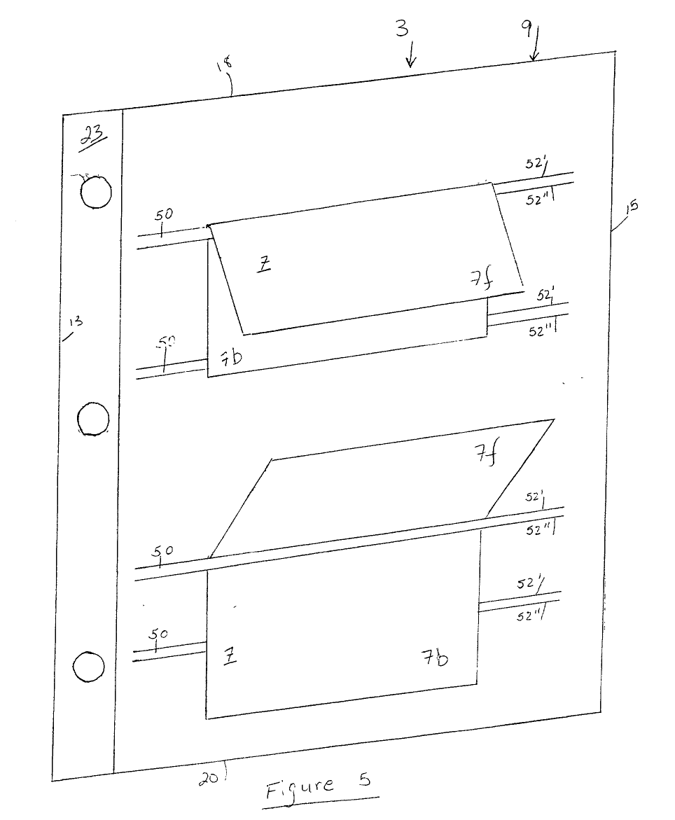

FIG. 5 shows a greeting card album page according to a fifth embodiment of the invention. The greeting card album page 3 is composed of a backing sheet 9 having a left edge 13, right edge 15, top edge 18, and bottom edge 20, and a fastening section 23 along the left edge for engagement with a fastener of the album. A plurality of narrow strips 50 are formed by cutting pairs of slits 52′ and 52″ into the backing sheet. Each strip is sized to receive the fold line of a greeting card. A card is mounted on an album page such that both frontfolds 7f and backfolds 7b of the card 7 then hang from a particular strip 50 on the front of the page 3. The strips 50 may be located adjacent to one another such that the cards 7 will overlap in a cascading manner when stored (not shown). A particular greeting card can be readily viewed even though the card may be surrounded by adjacent cards. In an alternative embodiment, the strips may be arranged vertically and therefore suitable for vertically-opening cards.

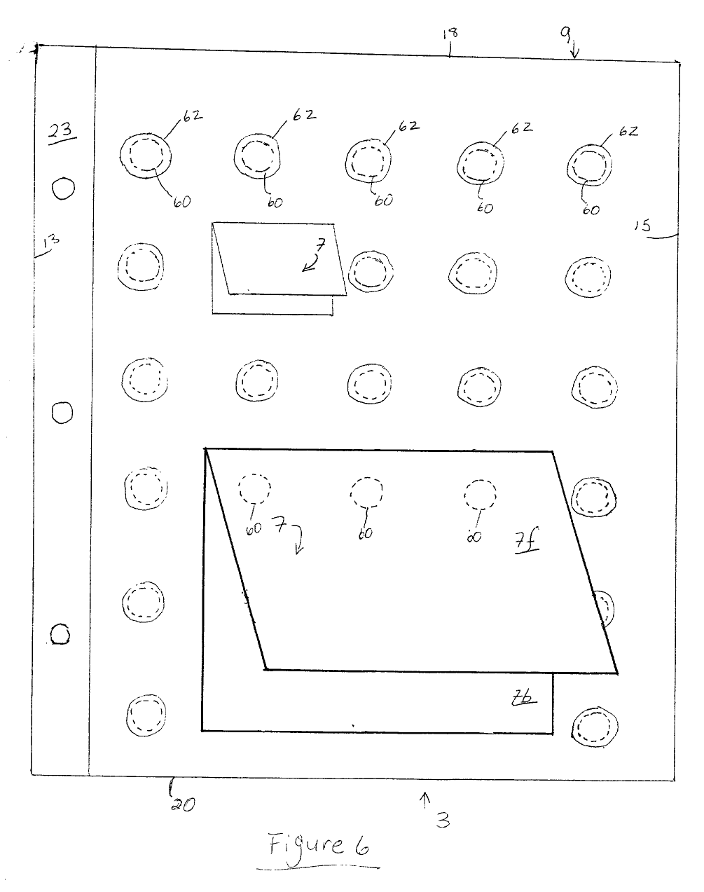

FIG. 6 shows a greeting card album page according to a sixth embodiment of the invention. This embodiment is suitable for both vertically and horizontally opening cards. The greeting card album page 3 is composed of a backing sheet 9 having a left edge 13, right edge 15, top edge 18, and bottom edge 20. A fastening section 23 is disposed along the left edge 13 for engagement with a fastener of the album (not shown in the figure). On the top half of the figure are shown a plurality of adhesive patches 60 (shown using a dashed line) covered by a wholly or partly detachable protective overlay 62 (shown using a solid line) arranged on the backing sheet 9. The adhesive patches may be varied in size in number on a page, and may be arranged in a particular pattern. A small card 7 is affixed to a single adhesive patch on the page 3. In FIG. 6, protective overlays 62 are shown into the shape of a circle, although the protective overlay 62 may be in any shape, such as a heart, star, or rainbow. The overlay may also be optionally imprinted with a graphical element, such as a birthday cake or a text phrase such as “Happy Birthday”.

On the bottom half of the figure, a mounted card 7 is shown. To mount a card 7, the protective overlay 62 covering one or more adhesive patches 60 is wholly or partly removed and the backfold 7b of the card is then removably affixed to the exposed adhesive patch. The front-fold 7f free to open and close as desired. The number of protective overlays 62 removed in order to mount the card will vary depending on the size of the card 7 and the size of the adhesive patches 60. Obviously, larger cards will take up more space on the page 3 than will smaller cards. In this embodiment, adhesive patches 60 which are not required to mount a card will normally not be exposed by removal of the protective overlay 62. In FIG. 6, three patches located behind the greeting card are shown as dashed circles. The card may be repositioned by merely lifting the card from the page and placing it in another position on the same or different page.

If overlays 62 are imprinted with a phrase or design, any overlays remaining on a page after a card is mounted can provide an additional visual cue regarding the occasion of the card. For example, if overlays 62 on a particular page 3 are imprinted with a birthday cake, a birthday card can be mounted on the page, and the visible overlays 62 on the sheet will reinforce the birthday theme of the card.

FIG. 7 shows a greeting card album in accordance with the invention. The album comprises a binder 64 having a front cover 66, a back cover 68, and a binder fastener 70 for retaining one or more pages 3 between the covers. The fastener 70 may comprise a plurality of rings 72 and be opened and closed in a conventional manner so that pages 3 may be added to or removed from the binder 64. One or more pages 3 described above may be mounted in the album to store and display greeting cards 7. In addition, the front or back covers 66 and 68 could include a general purpose pocket (not shown) for storing oversized cards that may not fit within the pockets on the pages provided within the album.

While the invention has been shown and described with reference to particular embodiments, those skilled in the art will understand that various changes in form and details may be made without departing from the spirit and scope of the invention.

What is claimed is:

1. A greeting card album page for holding and displaying vertically opening greeting cards comprising:
a backing sheet having left, right, top and bottom edges and a fastening section along the left edge for engagement with a fastener of the album; and
one or more vertical pockets over the backing sheet, each pocket formed by a transparent overlay having an upper edge, a lower edge, and a side edge connected to the backing sheet;
each pocket for receiving a portion or all of a greeting card.

2. A greeting card album page according to claim 1, wherein the page comprises a plurality of vertical pockets.

3. A greeting card album page according to claim 1, wherein the upper edge of the transparent overlay is connected to the top edge of the backing sheet, and the bottom edge of the transparent overlay is connected to the bottom edge of the backing sheet.

4. A greeting card album page according to claim 2, wherein the pockets cover the entire page and are adapted for receiving a portion of the back fold of a greeting card such that the cards will overlap in a cascading manner when stored.

5. A greeting card album page for holding and displaying horizontally opening greeting cards comprising:
a backing sheet having left, right, top and bottom edges and a fastening section along the left edge for engagement with a fastener of the album; and
one or more horizontal pockets over the backing sheet, each pocket formed by a transparent overlay having an inner edge, an outer edge, and a bottom edge connected to the backing sheet;
each pocket for receiving a portion or all of the greeting card.

6. A greeting card album page according to claim 5 wherein the page comprises a plurality of horizontal pockets.

7. A greeting card album page according to claim 6, wherein the pockets cover the entire page and are adapted for receiving a portion of the back fold of a greeting card such that the cards will overlap in a cascading manner when stored.

8. A greeting card album page according to claim 5, wherein the inner edge of the transparent overlay is connected to the left edge of the backing sheet, and the outer edge of the transparent overlay is connected to the right edge of the backing sheet.

9. A greeting card album page for holding and displaying greeting cards comprising:
a backing sheet having left, right, top and bottom edges and a fastening section along the left edge for engagement with a fastener of the album; and
a plurality of strips formed by cutting pairs of slits into the backing sheet, each strip for receiving the fold line of a greeting card.

10. A greeting card album page according to claim 8, wherein the strips are located adjacent to one another such that the cards will overlap in a cascading manner when stored.

11. A greeting card album page according to claim 8, wherein the strips are oriented horizontally or vertically on the page.

12. A greeting card album page for holding and displaying greeting cards, comprising:
a backing sheet having left, right, top, and bottom edges and a fastening section along the left edge for engagement with a fastener of the album; and
a plurality of adhesive patches disposed on the backing sheet.

13. A greeting card album page according to claim 12, further comprising a plurality of detachable protective overlays covering each of the adhesive patches.

14. A greeting card album page according to claim 13, wherein the protective overlay is imprinted with a graphical element.

15. A greeting card album for holding and displaying greeting cards, comprising:
a binder having front and back covers and a fastener for retaining one or more pages between the covers; and
one or more of the pages of any of claims 1-14 mounted within the fastener.
